(19) United States
(12) Patent Application Publication
(10) Pub. No.: US 2007/0272061 A1
(43) Pub. Date: Nov. 29, 2007

(54) Hand tool with replaceable bit

(76) Inventor: Chih-Ching Hsieh, Taichung City (TW)

Correspondence Address: PHILLIP LIU, 6980, WHITEOAK DR., RICHMOND, BC, V7EAZ9, CA

(21) Appl. No.: 11/441,039

(22) Filed: May 26, 2006

(51) Int. Cl. B25B 23/16; B25G 1/04; B25G 1/00

(52) U.S. Cl. 81/177.85; 81/177.2

(57) ABSTRACT

A hand tool includes a handle having a reception recess defined in an end thereof and a bit is removably inserted into the reception recess. The bit is positioned in the reception recess by a positioning device. A biasing device is located between the bit and an inner end of the reception recess so as to push the bit toward a direction away from the reception recess when replacing another bit.

### FIELD OF THE INVENTION

The present invention relates to a hand tool with a replaceable bit which is pushed by a biasing device so that when the replaceable bit can be easily removed from the hand tool.

### BACKGROUND OF THE INVENTION

A conventional hand tool generally includes a function head and a handle, the function head provides specific function for mounting the objects of different shapes and sizes. The function head cannot be replaced so that the user usually prepares a lot of different types of hand tools so as to deal with the objects to be tightened or loosened. The hand tools are heavy and occupy a large space. Some manufacturers develop replaceable bits which can be connected to an end of a handle so that the user prepares only one handle which can be cooperated with different bits. Nevertheless, the bits have to be pulled out from the reception recess of the handle by a certain effort which can be further improved.

The present invention intends to provide a hand tool that has a reception recess defined in an end of the handle and a replaceable bit is removably received in the reception recess. A biasing device is located between the reception recess and the bit so that when the bit can be easily pushed in a direction away from the recess when replacing the bit.

### SUMMARY OF THE INVENTION

The present invention relates to a hand tool that comprises a handle having a reception recess defined in an end thereof and a bit is removably inserted into the reception recess by an insertion of the bit. A positioning device positions the insertion in the reception recess. A biasing device is located between the insertion and an inner end of the reception recess so as to push the bit toward a direction out from the reception recess.

The primary object of the present invention is to provide a hand tool that has a reception recess for bits to be removably inserted therein, a biasing device is located between the bit and an inner end of the reception recess so that when removing the bit, the biasing device pushes the bit out from the reception recess.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hand tool of the present invention with a first embodiment of the biasing device;

FIG. 2 is a perspective view to show that the bit is inserted into the reception recess of the handle of the present invention;

FIG. 3 is a cross sectional view to show the bit and the handle;

FIG. 4 is a cross sectional view to show that the bit is inserted in the reception recess of the handle;

FIG. 5 is an exploded view to show the hand tool of the present invention with a second embodiment of the biasing device;

FIG. 6 is a perspective view to show that the bit is inserted into the reception recess of the handle in FIG. 5;

FIG. 7 is a cross sectional view to show the bit and the handle in FIG. 5, and

FIG. 8 is a cross sectional view to show that the bit is inserted in the reception recess of the handle in FIG. 5.

### DETAILED DESCRIPTION OF THE PREFERRED EMBODIMENT

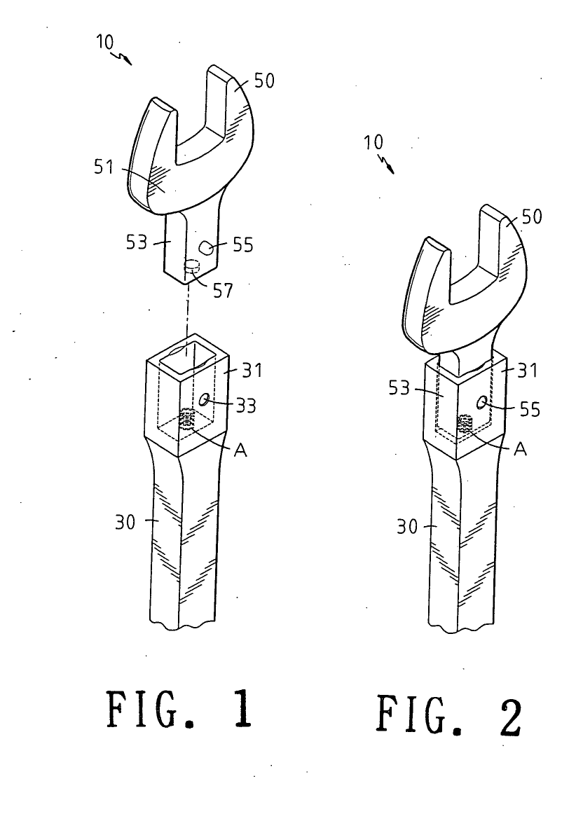

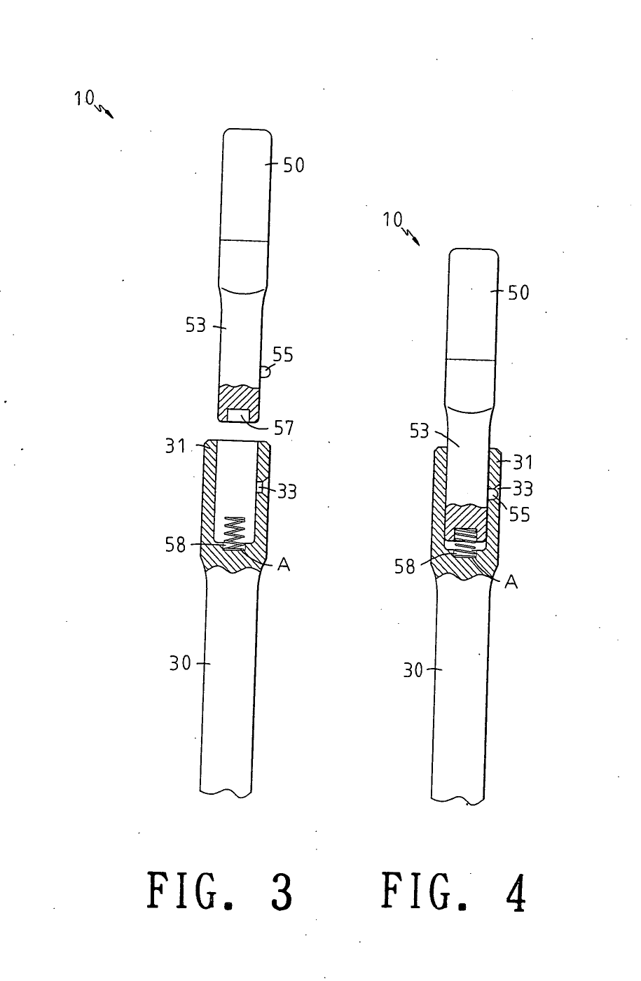

Referring to FIGS. 1 to 4, the hand tool 10 of the present invention comprises a handle 30 and a rectangular reception recess 31 is defined in an end thereof. A bit 50 includes a head 51 with two jaws and an insertion 53 which is connected with the head 51 and can be inserted into the reception recess 31. A positioning device positions the insertion 53 in the reception recess 31 and includes a through hole 33 defined through a wall of the reception recess 31. The insertion 53 has a bead 55 which is retractably engaged with the insertion 53, the bead 55 is engaged with the through hole 33 so as to position the bit 50.

A biasing device is located between the insertion 53 and an inner end of the reception recess 31 so as to push the bit 30 toward a direction out from the reception recess 31. The biasing device includes a first dent 57 defined in a distal end of the insertion 53 and a second dent 58 is defined in the inner end of the reception recess 31. A spring “A” has one end engaged with the first dent 57 and the other end of the spring “A” is engaged with the second dent “58”. When the user pushes the bead 55 inward and the bead 55 is disengaged from the through hole 33. The spring “A” pushes the bit 50 in the direction out from the reception recess 31 so that the user simply picks the bit 50 out from the reception recess 31.

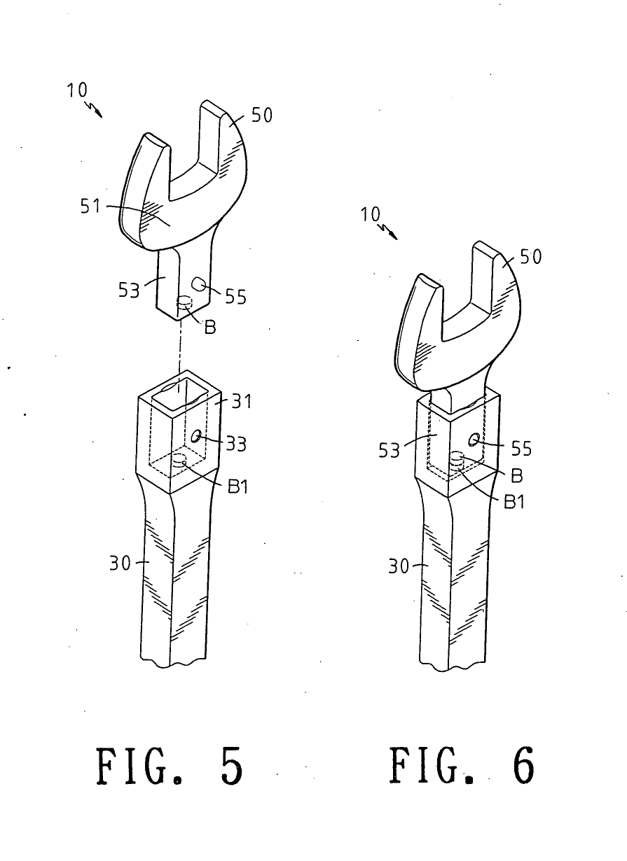

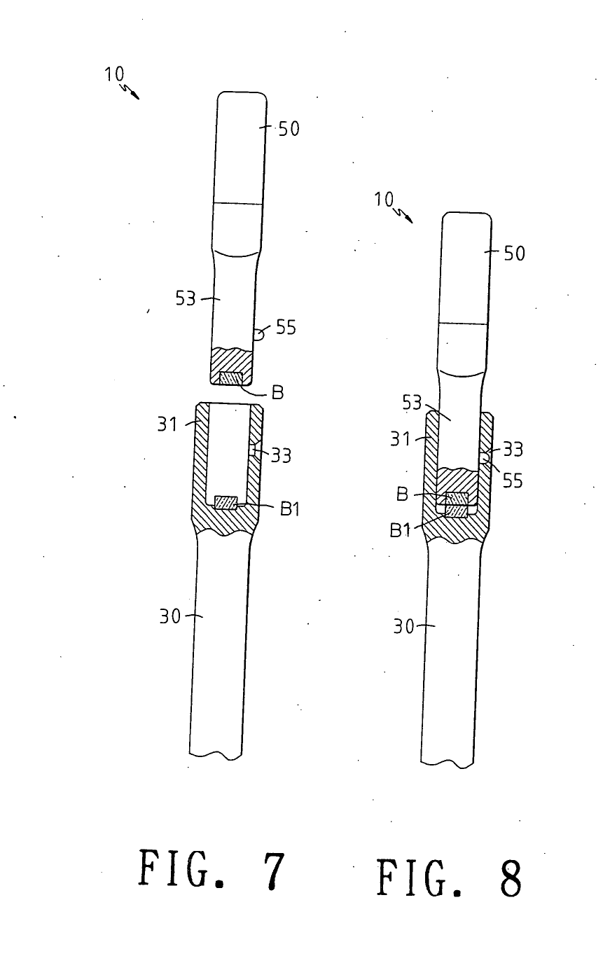

Referring to FIGS. 5 to 8, which show a second embodiment of the biasing device, the biasing device includes a first magnet “B” connected to a distal end of the insertion 53 and a second magnet “B1” is connected to the inner end of the reception recess 31. The first and second magnets “B”, “B1” are located so that two same polarities of the first and second magnets “B”, “B1” face toward each other. By the two same polarities, a force pushes the bit 50 away from the handle 30, so that the bit 50 can be pushed toward the direction out from the reception recess 31.

While we have shown and described the embodiment in accordance with the present invention, it should be clear to those skilled in the art that further embodiments may be made without departing from the scope of the present invention.

1. A hand tool comprising:
a handle having a rectangular reception recess defined in an end thereof;
a bit having an insertion which has a rectangular cross section and is removably inserted into the rectangular reception recess, the insertion having a bead which is retractably engaged with the insertion, a positioning device positioning the insertion in the rectangular reception recess, the positioning device including a through hole defined through a wall of the rectangular reception recess, the bead engaged with the through hole and can be pushed inward to disengage from the through hole, and
a biasing device located between the insertion and an inner end of the rectangular reception recess so as to push the bit toward a direction out from the rectangular reception recess.

2. The hand tool as claimed in claim 1, wherein the biasing device includes a spring which is biased between the insertion and the inner end of the reception recess.

3. The hand tool as claimed in claim 2, wherein the insertion has a first dent defined in a distal end thereof and a second dent is defined in the inner end of the reception recess, the spring has one end engaged with the first dent and the other end of the spring is engaged with the second dent.

4. The hand tool as claimed in claim 1, wherein the biasing device includes a first magnet connected to a distal end of the insertion and a second magnet connected to the inner end of the reception recess, the first and second magnets, are located so that two same polarities of the first and second magnets face toward each other.

5. The hand tool as claimed in claim 1, wherein the positioning device includes a through hole defined through a wall of the reception recess and the insertion has a bead which is retractably engaged with the insertion, the bead is engaged with the through hole.
